(19) United States
(12) Patent Application Publication
(10) Pub. No.: US 2004/0083583 A1
(43) Pub. Date: May 6, 2004

(54) Retention structure for a fastener

(76) Inventors: Brian Bradley, Rochester Hills, MI (US); Stan Trala, Emmett, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/288,017

(22) Filed: Nov. 5, 2002

(51) Int. Cl. A44B 21/00; F16B 19/00

(52) U.S. Cl. 24/297

(57) ABSTRACT

A retention structure includes a retainer housing for retaining an object, such as a fastener, commonly used to secure trim panel to an inner vehicle panel. The retainer housing is defined by a first sidewall, a second sidewall, a back wall, and a base. The first sidewall, the second sidewall and the back wall extend from the substrate to the base, and a retention portion for retaining an object. The base includes a first deflection slot, a second deflection slot, a first tab formed by the first deflection slot and an insertion slot, and a second tab formed by the second deflection slot and the insertion slot. The object is inserted into the retention portion with a relatively low insertion force and is retained within the retention portion with a relatively high retention force. The retainer housing can be integrally formed with a substrate by using well known molding techniques. It is submitted with the understanding that it will not be used to interpret or limit the scope or meaning of the claims.

### TECHNICAL FIELD

The present invention relates to a retention structure for a fastener and in particular to a retention structure that retains fasteners with a low insertion force and a high retention force.

### BACKGROUND OF THE INVENTION

It is well known to use fasteners for connecting a trim panel to an inner panel of a vehicle. One common type of fastener is the “Christmas-tree” type fastener. This type of fastener is attached to the trim panel at the site where the trim panel is manufactured. Once attached, the trim panel and fasteners may be shipped to a different location where assembly of the trim panel and fasteners onto the vehicle takes place. During shipment the fasteners may fall off the trim panel due to the low retention force exerted by the trim panel onto the fasteners. The advantages of pre-assembling the trim panel and fasteners are not realized because the fasteners must be re-inserted onto the trim panel. Increasing the retention force exerted by the trim panel on the fastener increases the force required to insert the fastener into the trim panel. This increased insertion force may cause the fastener to break or even worse, cause injury to the individual during installation of the fastener into the trim panel.

### SUMMARY OF THE INVENTION

The inventors of the present invention have recognized these and other problems associated with conventional retention structures for fasteners. To this end, the inventors have developed a retention structure comprising a retainer housing defined by a first sidewall, a second sidewall, a back wall, and a base. The first sidewall, the second sidewall and the back wall extend from a substrate to the base. The retention structure further comprises a retention portion for retaining an object, and means for inserting the object into the retention portion with a relatively low insertion force, and for retaining the object within the retention portion with a relatively high retention force.

Another aspect of the invention comprises a retention assembly comprising a substrate, and a retainer housing defined by a first sidewall, a second sidewall, a back wall, and a base. The first sidewall, the second sidewall and the back wall extend from the substrate to the base, and a retention portion for retaining an object. The base includes a first deflection slot, a second deflection slot, a first tab formed by the first deflection slot and an insertion slot, and a second tab formed by the second deflection slot and the insertion slot, wherein the object is inserted into the retention portion with a relatively low insertion force, and wherein the object is retained within the retention portion with a relatively high retention force.

### BRIEF DESCRIPTION OF THE DRAWINGS

The present invention will now be described, by way of example, with reference to the accompanying drawings, in which:

FIG. 1 is a perspective view of a substrate and a retention structure retaining a fastener according to an embodiment of the invention.

FIG. 2 is an exploded view of region 1 of FIG. 1.

FIG. 3 is a perspective view of a retention structure of FIG. 1 with the fastener not shown for clarity.

FIG. 4 is a cross section view of a retention structure taken along line 4-4 of FIG. 2.

### DESCRIPTION OF THE PREFERRED EMBODIMENT

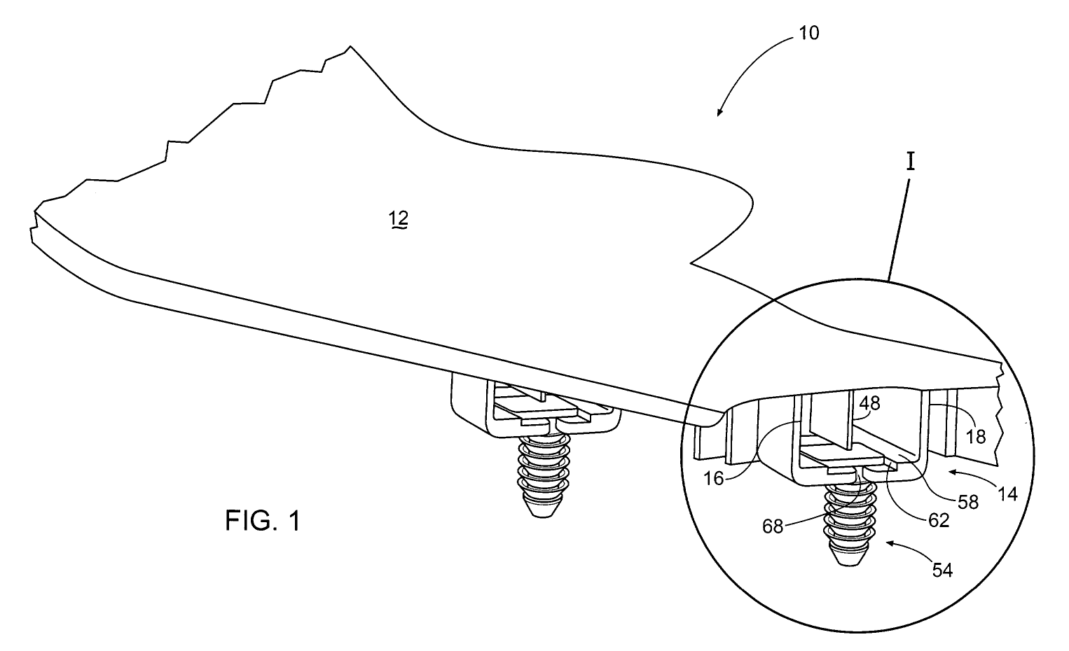

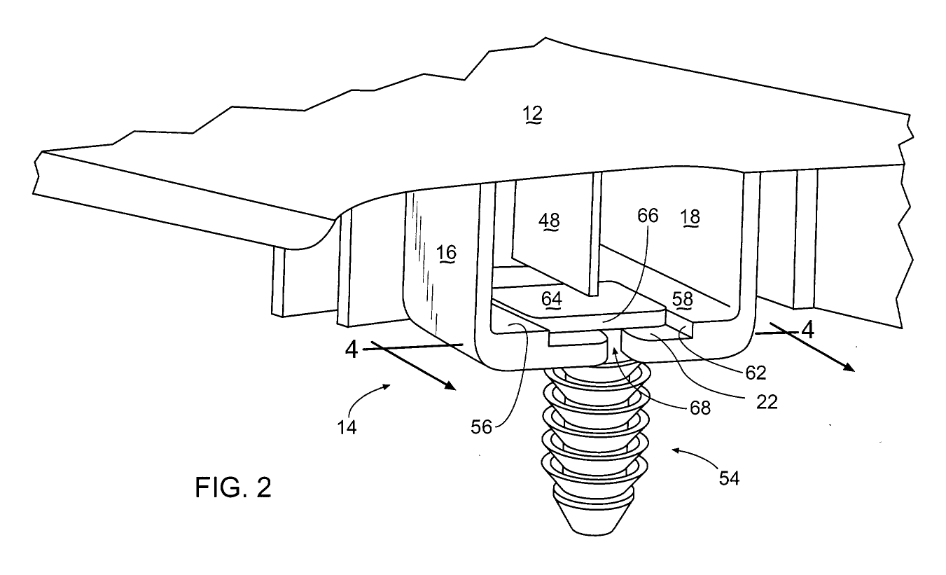

Referring now to FIGS. 1-3, a retention structure, generally shown at 10, is shown according to an embodiment of the invention. In general, the retention structure 10 comprises a substrate 12 and a retainer housing 14 extending away from the substrate 12. Preferably, the retention structure 10 and the substrate 12 are integrally formed of a molded plastic material, or the like. In the illustrated embodiment, the retainer housing 14 is defined by a first sidewall 16, a second, opposing sidewall 18, a back wall 20 and a base 22. A retention tab 48 may extend vertically downward into the retainer housing 14 from the substrate 12. However, the invention can be practiced without the retention tab 48. The first sidewall 16 and the second sidewall 18 extend downward from the substrate 12 to horizontal surfaces 56, 58, respectively. The ledges or horizontal surfaces 56, 58 terminate at surfaces 60, 62 that extend vertically downward from the horizontal surfaces 56, 58 to the base 22. The back wall 20 also extends downward from the substrate 12 to the base 22, thereby joining the base 22 to the substrate 12. In the illustrated embodiment, the base 22 is substantially parallel to the substrate 12. However, it can be appreciated that the base 22 does not have to be substantially parallel to the substrate 12.

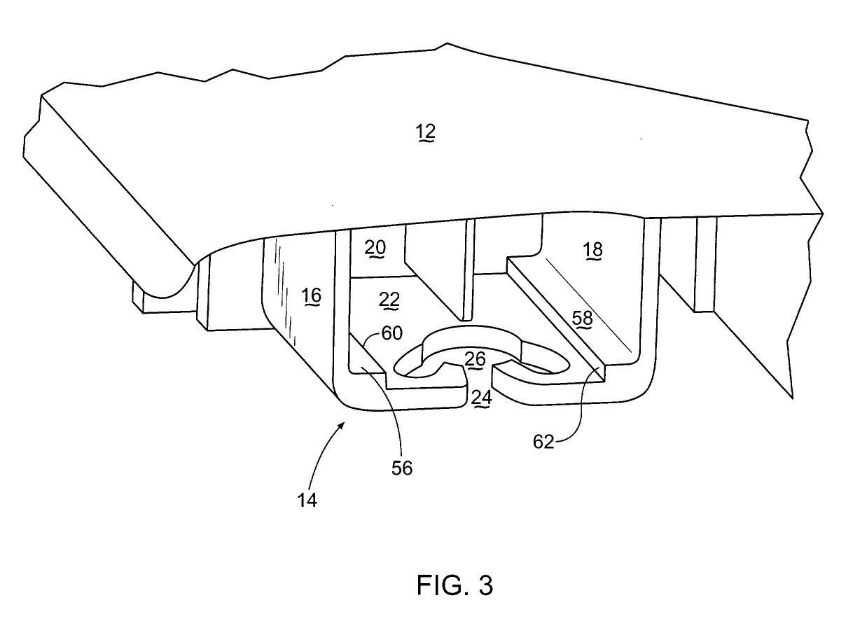

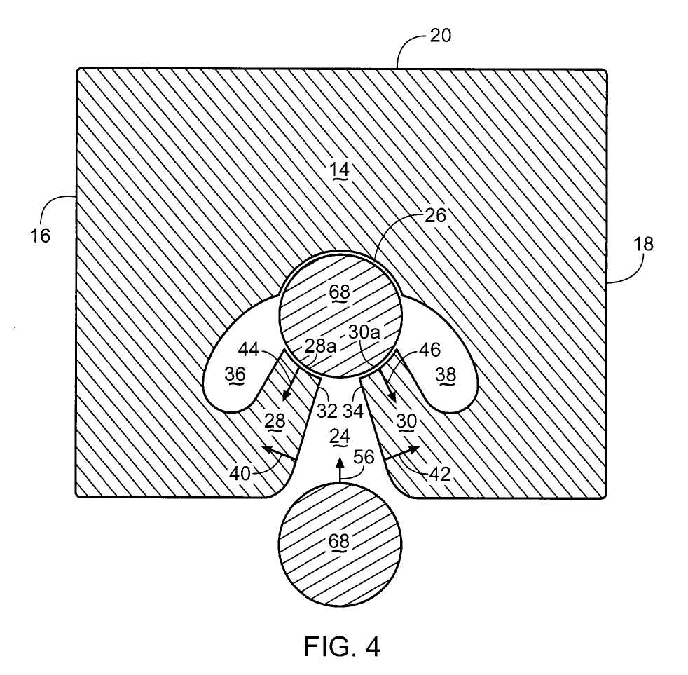

Referring now to FIGS. 3 and 4, the base 22 of the retainer housing 14 includes an insertion slot 24, a retention portion 26, a first tab 28 formed between the insertion slot 24 and a first deflection slot 36, and a second tab 30 formed between the insertion slot 24 and a second deflection slot 38. The insertion slot 24 is defined by a first wall 32 and a second wall 34 angled inwardly toward each other to help guide the fastener 54 when the fastener 54 is inserted into the retention portion 26 in the direction shown by arrow 56 in FIG. 4. The first wall 32 and the second wall 34 do not need to be angled toward each other to practice the invention. One aspect of the invention is a relatively low insertion force is needed to insert the fastener 54 into the retention portion 26 of the retention structure 10. To accomplish such a relatively low insertion force, the stem 68 of the fastener 54 exerts a tangential force on the first and second tabs 28, 30, thereby causing the first and second tabs 28, 30 to deflect in the direction of the arrows 40, 42, respectively. The first and second deflection slots 36, 38 allow the first and second tabs 28, 30 to deflect easily because of the width of the first and second tabs 28, 30 and the material used to form the base 22 of the retention structure 10. As the fastener 54 is inserted further into the insertion slot 24, the tabs 28, 30 continue to deflect until a maximum point of deflection when the stem 68 of the fastener 54 reaches the narrowest portion between the walls 32, 34 of the insertion slot 24.

Once the fastener 54 is completely inserted into the retention portion 26, the first and second tabs 28, 30 return to their initial positions due to the resilient nature of the plastic material, as shown in FIG. 4. Another aspect of the invention is the relatively high retention force needed to remove the fastener 54 once the fastener 54 is completely inserted into the retention portion 26. When attempting to remove the fastener 54, the stem 68 of the fastener 54 contacts the first and second tabs 28, 30 along the surfaces 28a, 30a. As a result, the stem 68 of the fastener 54 exerts a force on the first and second tabs 28, 30 in the direction of arrows 44, 46 respectively. Because the direction of the force is substantially perpendicular to the surfaces 28a, 30a, the tabs 28, 30 do not deflect easily and a relatively high retention force is necessary to remove the fastener 54 from the retention structure 10. Thus, the tabs 28, 30 and the deflection slots 36, 38 provide a means for inserting the fastener 54 in the retention portion 26 with a relatively low insertion force, but retaining the fastener 54 in the retention portion 26 with a relatively high retention force.

Another aspect of the invention is that the fastener 54 is prevented from lateral (horizontal) and vertical movement once the fastener 54 is completely inserted into the retention portion 26. Specifically, the vertical surfaces 60, 62 of the retention housing 14 abuts the side surface 66 of the fastener 54, thereby restricting the lateral movement of the fastener 54. In addition, the retention tab 48 extending downward from the substrate 12 abuts the top portion 64 of the fastener 54 and the bottom surface 65 of the top portion 64 rests on the base 22 of the retention housing 14, thereby restricting vertical movement of the fastener 54. It will be appreciated that the retention structure 10 can be designed with any desired geometric shape to accommodate objects other than the fastener 54 as shown. Further, it will be appreciated that the invention is not limited to retaining a fastener, and that the invention can be practiced to retain objects other than fasteners.

In the illustrated embodiment, the retention structure 10 is designed such that the fastener 54 can be inserted with a relatively low insertion force, but is secured within the retainer housing 14 by a relatively high retention force. The ease of insertion and difficulty of removal of the fastener 54 allows the fastener 54 to be inserted into the retention structure 10 at one location, and then shipped to another location without falling off during shipment before being inserted into a vehicle.

While the invention has been specifically described in connection with certain specific embodiments thereof, it is to be understood that this is by way of illustration and not of limitation, and the scope of the appended claims should be construed as broadly as the prior art will permit. Claims

What is claimed is:

1. A retention structure, comprising:
a retainer housing defined by a first sidewall, a second sidewall, a back wall, and a base, said first sidewall, said second sidewall and said back wall extending from a substrate to said base, said base including a retention portion for retaining an object; and
means for inserting said object into said retention portion with a relatively low insertion force, and for retaining said object within said retention portion with a relatively high retention force.

2. The retention structure according to claim 1, wherein said means comprises a first deflection slot, a second deflection slot, a first tab formed between said first deflection slot and an insertion slot, and a second tab formed between said second deflection slot and said insertion slot.

3. The retention structure according to claim 2, wherein said fastener exerts a tangential force on said first and second tabs when inserted into said insertion slot.

4. The retention structure according to claim 2, wherein said fastener exerts a force substantially perpendicular to said first and second tabs when removed from said retention portion.

5. The retention structure according to claim 1, wherein said insertion slot includes first and second walls angled inwardly toward each other to help guide said fastener when inserted into said retention portion.

6. The retention structure according to claim 1, wherein said retention structure includes a retention tab that extends from said substrate toward said base.

7. The retention structure according to claim 6, wherein said retention tab abuts a top portion of said fastener, thereby restricting vertical movement of said fastener.

8. The retention structure according to claim 1, wherein said retention structure includes a first ledge that extends from said first sidewall to a first vertical surface, and a second ledge that extends from said second sidewall to a second vertical surface, wherein said first ledge and said second ledge abut a side wall of said fastener, thereby restricting lateral movement of said fastener.

9. A fastener assembly, comprising:
a substrate; and
a retainer housing defined by a first sidewall, a second sidewall, a back wall, a base, said first sidewall, said second sidewall and said back wall extending from said substrate to said base, and a retention portion for retaining an object, said base including a first deflection slot, a second deflection slot, a first tab formed between said first deflection slot and an insertion slot, and a second tab formed between said second deflection slot and said insertion slot,
wherein said object is inserted into said retention portion with a relatively low insertion force, and wherein said object is retained within said retention portion with a relatively high retention force.

10. The retention structure according to claim 9, wherein said fastener exerts a tangential force on said first and second tabs when inserted into said insertion slot.

11. The retention structure according to claim 9, wherein said fastener exerts a force substantially perpendicular to said first and second tabs when removed from said retention portion.

12. The retention structure according to claim 9, wherein said insertion slot includes first and second walls angled inwardly toward each other to help guide said fastener when inserted into said retention portion.
